(19) United States
(12) Patent Application Publication
(10) Pub. No.: US 2007/0118442 A1
(43) Pub. Date: May 24, 2007

(54) METHOD AND SYSTEM FOR A DIGITAL VIDEO DISK CATALOG

(76) Inventors: JAMES P. COLLAS, San Diego, CA (US); CHRISTOS A. NICOLAIDIS, Carlsbad, CA (US); DANIEL E. SHADWELL, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/538,756

(22) Filed: Oct. 4, 2006

Related U.S. Application Data
(60) Provisional application No. 60/724,414, filed on Oct. 7, 2005.

(51) Int. Cl. G06F 17/30; G06Q 30/00; G07F 7/00; H04N 7/16; G06F 13/00; H04N 5/445; H04H 9/00

(52) U.S. Cl. 705/27; 725/60; 725/9; 705/26

(57) ABSTRACT

An interactive, informative and entertaining digital shopping catalog offered on a digital data carrier (“DVD”) which provides the features of interactive playing of the DVD media files, tracking of the past media files played and ability to purchase products on-line or by telephone connection.

### PRIORITY

This application claims the benefit of U.S. Provisional application No. 60/724,414, filed Oct. 7, 2005 and titled Method and System for DVD Movie Update.

### BACKGROUND

1. Field of the Invention

The present invention generally relates to the field of Digital Video Disk (DVD) technology, and more particularly relates to the interactive playing of the DVD content stream and purchasing products.

### SUMMARY

The present invention is directed to various aspects of an interactive, informative and entertaining digital shopping catalog offered on a DVD or digital data carrier (“DVD”). One embodiment of the present invention is a digital shopping catalog. The digital catalog offers an interactive DVD experience by providing a DVD containing an informative and promotional material on a variety of topics it further includes the ability to purchase the products. In a further aspect a system and method include showcasing produces or services in an interactive, informative and entertaining multi-media format stored on a DVD. References to a DVD throughout this application are intended to also refer to other forms of digital data storage or carriers including compact discs. For example, the digital catalog can present information on the latest development in the video industry and it can showcase a variety of video products. In particular, the DVD can include interviews with movie stars, critics' insights, movie recommendations, movie trailers, and movie trivia games. Alternatively, the interactive digital shopping catalog can promote and provide information about products beyond DVDs such as wine, jewelry, etc.

The DVD can be played on a media player, such as DVD player or a DVD driver in a computer (e.g. PC). Alternatively, the content of the DVD can be provided via a web site or an electronic file. While playing the DVD, the media player displays an interactive catalog of services and products. A product or service can be ordered by placing an order over the phone, over the Internet, or by sending an e-mail. Alternatively, the products/service can be purchased in a retail store

The digital catalog system and method can provide a unique, viewer-guided “show” of information. A viewer may navigate through the show using innovative and interactive menus stored on the DVD. By using the menus, the viewer can adjust a variety of parameters involved in the playing of the show. For example, the viewer may change: the pace of the show, focus of the show, type and amount of the displayed information, and type and amount of interactions with the playing of the show. The control is easy and intuitive, and may be performed from a variety of interface input devices compatible with DVD players. Examples of such devices include DVD remote control, keyboard, and PDA. Alternatively, the show can be stored on a computer readable memory storage device and played on a computer.

### BRIEF DESCRIPTION OF THE DRAWINGS

The details of the present invention, both as to its structure and operation, may be gleaned in part by a study of the accompanying drawings, in which like reference numerals refer to like parts, and in which:

FIG. 1A is a block diagram illustrating exemplary modules of a digital data carrier according to an embodiment of the present invention.

FIG. 1B is a block diagram illustrating an interactive, viewer—driven system for the playing of DVD modules according to an embodiment of the present invention;

FIG. 2 is a functional block diagram illustrating an example process for the playing of the digital catalog according to an embodiment of the present invention;

FIG. 3 is a high level flow chart illustrating an example process for the playing of the DVD in one embodiment of the present invention;

FIG. 4 is a flow chart illustrating examples of DVD modules according to an embodiment of the present invention;

FIG. 5 is a flow chart illustrating an example process for the playing of one DVD module in one embodiment of the present invention; and

FIG. 6 is a flow chart illustrating an example process for the playing of a sequence of DVD modules in one embodiment of the present invention.

FIG. 7 is a block diagram illustrating an example computer system that may be used in connection with various embodiments described herein.

### DETAILED DESCRIPTION

Embodiments of the present invention relate to a system and method for the interactive playing, and tracking of a media files or multi-media stream data on a multimedia display. This system further allows the purchase of products via a direct internet connection or telephone dial up.

In one embodiment, the files can contain, for example, movie clips, movie reviews, movie trailers, interviews with movie starts and movie trivia. The files can promote a variety of goods, such as, for example, video cassettes and DVDs. The files can also promote a variety of services, such as: video access service (e.g. “video on demand”), and video renting service (e.g. ordering rentals via an e-mail, phone, Internet (NetFlix®), etc.). However, the described system and method also apply to other products and services and the invention is not limited to movies. For instance, the files can promote a variety of products beyond the DVDs such as wine, jewelry, etc. This application also incorporates by reference U.S. application Ser. No. 11/531,134 and titled Method and System for multi-media gift card system filed on Sep. 12, 2006.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention.

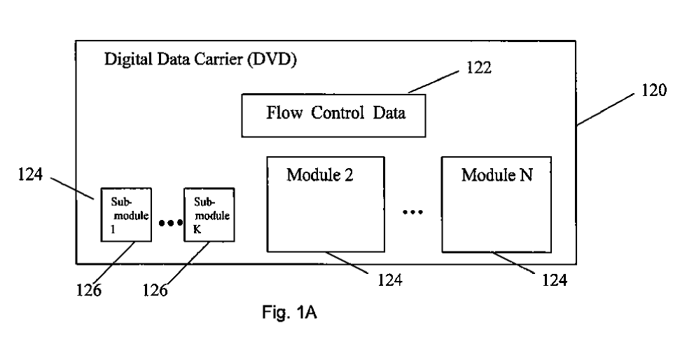

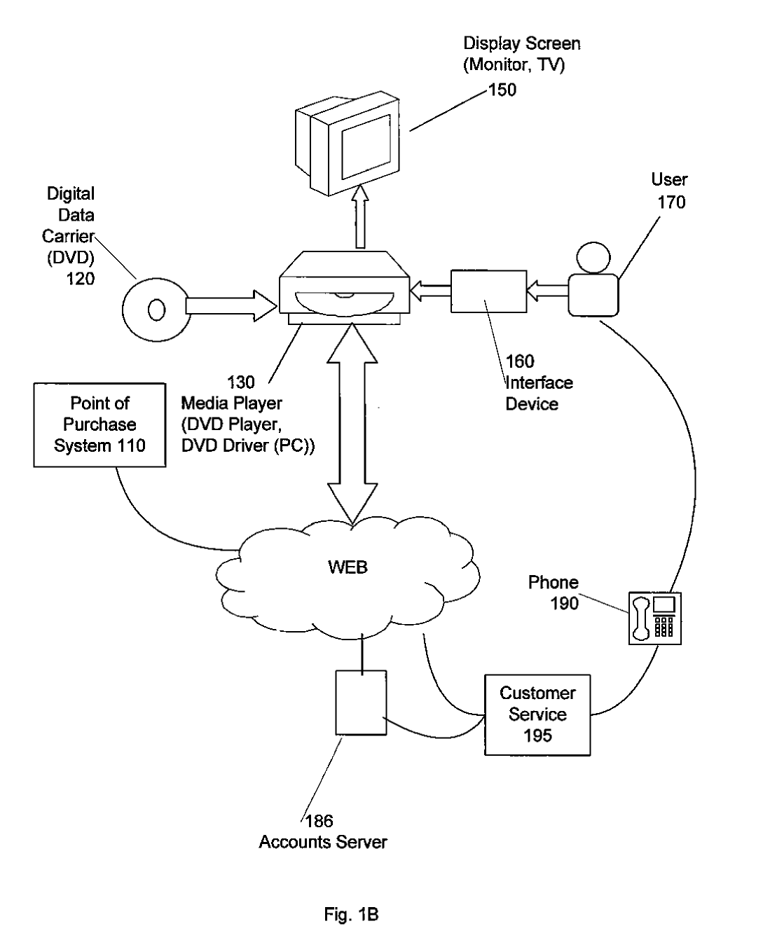

FIG. 1A is a block diagram illustrating exemplary modules of a digital data carrier which is a digital catalog 120 (“DVD”). A digital catalog 120 includes flow control data 122, modules 124 and sub-modules 126. The flow control data 124 contains information needed to initialize the reading of other modules from the DVD 120. The modules 124 and sub-modules 126 can contain menus, files, tracking information and purchasing information. A menu is a stream of data that allows for the input from the user, for example, the interactive playing of the modules 124 and sub-modules 126 from the DVD 120 on a multimedia display. Examples of menus can include initial menus and secondary menus. A file is a stream of data that can be non-interactively played on the multimedia display.

FIG. 1B provides a block diagram illustrating an interactive, viewer driven system for the playing of the digital catalog according to an embodiment of the present invention. The diagram illustrates the media player 130 accessing the digital catalog120 and displaying the content of the digital catalog 120 on a display screen 150. Examples of the media players 130 can include a DVD player and computer DVD driver, whereas examples of the display screens 150 can include a television monitor or computer monitor with speakers.

The media player 130 can access the flow control data 122, depicted in FIG. 1A. As shown in FIG. 1B, the media player 130 reads the flow control data 122 from the DVD 120 to play menus on the display screen 150. The media player 130 can also communicate with a user interface device 160 which collects inputs from a user 170. The user interface device 160 and the media player 130 provide the user 170 with interactive capabilities, such as, for example, the ability to display menus, select a subsequent menu from the current menu, select a file from a menu, play a file, stop/pause/resume the playing of a file, return to a previous menu, and play a default sequence of files. Examples of the user interface device 160 can include a remote control device, a computer keyboard, and personal digital assistant system (“PDA”).

The interface device 160 passes inputs from the user 170 to the media player 130. After the media player 130 accesses an introductory menu from the flow control data 122 (described in FIG. 1A), the display screen 150 displays the introductory menu. Then, the interface device 160 reads user inputs and passes them to the media player 130. After that, the media player 130 reads the user inputs and guides the user 170 accordingly, to either a default sequence of DVD files, or to a particular DVD file.

The media player 130 can also communicate with a “point of purchase” system 110 via a network connection such as the Internet. The media player 130 displays the information from the point of purchase system 110 on the display screen 150. The point of purchase system 110 contains the information helping the user 170 to purchase a product or service. Examples of the point of purchase systems 110 can include a website or a cable television video on demand ordering system. Examples of the products and services can include purchasing (or renting) of movies, music and games, or purchasing of wine, jewelry, etc.

The interactive catalog can also provide the user 170 with a telephone number 190 for a customer service system 195 which can be implemented as a call center using live operators or Voice Response Units (VRU), also known as Interactive Voice Response (IVR) or a combination of the two. The customer service system can also be a web server coupled to a network including the internet. The customer service system allows the customer to remotely purchase (purchasing without traveling to a store) the products in the catalogue using the account identifier. Alternatively, the catalog may provide a list of retail stores where the user 170 can purchase the products using the account identifier. Moreover, the catalog may provide the user 170 with information about a website from which the user 170 can order the products, or cable television site from which the user 370 can order, e.g., video on demand.

The media player 130 connected to a PC, or a media player which is Internet enabled, can access a web site over the Internet, initialize the Internet browser and pass information and pages between the web site and the PC. From the Internet browser, the user 170 can purchase products or services (remotely purchase). Using the Internet, the user 170 can input payment information, for example, a credit card number or gift card number, to pay for the products and services.

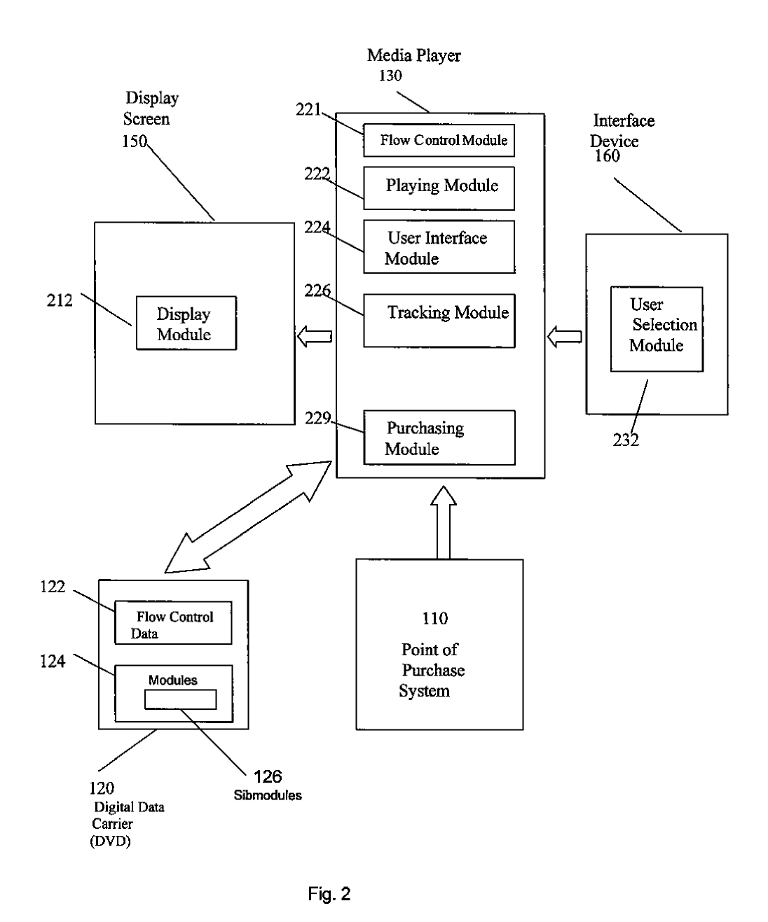

FIG. 2 provides a functional block diagram illustrating major functional blocks involved in the playing of the digital catalog by the system depicted in FIG. 1B. As shown in FIG. 2, the media player 130 can contain several modules, including a flow control module 221, a playing module 222, a user interface module 224, a tracking module 226 and a purchasing module 229. When the digital catalog 120 is loaded into the media player 130, the media player 130 accesses the flow control data 122 from the digital catalog 120. Then, the flow control data 122 originates the flow control module 221 of the media player 130.

As shown in FIG. 2, the media player 130 communicates with the display screen 150, which contains a display module 212. The flow control module 221 selects the files and/or data to be played from either digital catalog 120 or the point of purchase system 110. Then, the play module 221 accesses those files (either from the DVD 120 or the point of purchase system 1 10), and passes the files to the display module 212, which displays them on the display screen 150.

The media player 130 uses the flow control module 221 to select modules and sub-modules of the DVD 120 for playing. To select a next module or sub-module, the media player 130 can utilize a sequence of selections already made by a viewer, a selection made by the viewer at the given moment, and/or a default sequence of modules and sub-modules stored on the DVD 120.

To facilitate communication between the media player 130 and the user, the flow control module 221 communicates with the user interface module 224 of the media player 130. The user interface 224 receives user inputs collected by a user selection module 232 of the interface device 160. The flow control module 221 uses the user inputs to facilitate the navigation through the contents of the DVD 120 (or the point of purchase data).

The flow control module 221 of the media player 130 parses the user input and determines whether to retrieve a new file or menu from the DVD 120 (or from the point of purchase system 110), or to continue playing an already retrieved file. The flow control module 221 can also establish the sequence in which the files are played if the user provides no input.

Moreover, the flow control module 221 can communicate with the purchasing module 229 to access the information from the point of purchase system 110. As described in FIG. 1B, the point of purchase system 110 can be a website or a cable television “video on demand” ordering system. After the purchasing module 229 retrieves the information from the point of purchase system 110, the playing module 222 sends the information to the display module 212, which in turn, displays it on the display screen 150. Then, the user selection module 232 of the interface device 160, collects user inputs, and passes them to the user interface module 224. Subsequently, the flow control module 221 receives the user inputs and selects successive files for display.

One embodiment includes the tracking module 226. The tracking module 226 creates and maintains a tracking record of the sequence of DVD modules which are played by the media player 130, and creates a tracking record of user inputs. The flow control module 221 can use the tracking record created by the tracking module 226 when determining what file to play next.

When the media player is equipped with a network connection, the user may select to purchase a product promoted by the DVD 12 via the interface device 160. The flow control module 121 can invoke a browser using the data stored in the purchasing module 129. From the web browser, the user can access a customer service system 195, such as a website, and order a product or service. In one embodiment he content of the website the user is directed to is specific to the content of the DVD. For example, if the DVD is promoting a collection of classic movies available on DVD, the website is configured to allow easy purchasing of those promoted movies and would not present a larger or different collection of products. However, the website can allow the user to move to a different site with a different range of products.

To complete the transaction and pay for the product, the user can utilize a credit card or gift card. Alternatively, the user can contact the customer service system 395 by telephone 390. The phone contact instruction can be displayed by the flow control module 521. Using the phone, the user can purchase the product/service the same way as if he/she were using the customer service website. The user can also order the products using email.

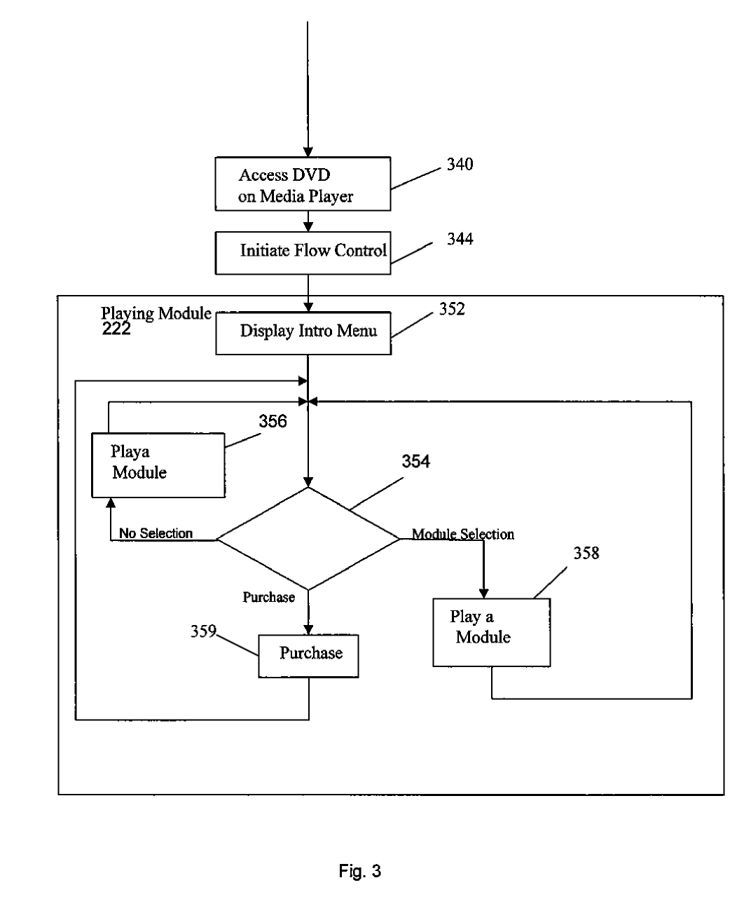

FIG. 3 is a high level flow chart illustrating a sequence of steps or processes performed by the functional blocks involved in the playing of the DVD in one embodiment of the present invention. In a first step 340, the media player accesses the content of the DVD. Accessing of the DVD begins with the reading of the flow control data from the DVD (FIG. 1A). In a next step 344, the media player initializes the flow control module 221 (FIG. 2). Then, the flow control module initializes the playing module 222 (FIG. 2). In the step 352, the flow control module 221 (FIG. 2) selects an introductory menu to be played. Then, at the same step 352, the playing module 222 (FIG. 2) retrieves the introductory menu from the DVD and the displaying module 212 (FIG. 2) displays the menu on the display screen. The introductory menu can contain a list of options available to the user. At the step 354, the user can either make a selection from the menu (e.g., via the user interface 160 (FIG. 2)), or make no selection.

If the user makes no selection, then, at a step 356, the media player plays a default module. As it was described in FIG. 2, the flow control module of the media player selects the next module based on the default sequence of modules (tracking record) stored on the DVD. However, the default sequence can vary according to the past selections (inputs) from the user and previously played modules (i.e. according to the tracking record of played modules). Once the playing of the default module is complete, at the step 354, the flow control module checks again whether there is new user input. The flow control module can also continuously monitor for user input to allow a user to stop playing a module and return to the menu.

If the user makes a valid selection from the displayed introductory menu, then, at the step 354, the flow control module of the media player parses the user input, and determines whether the input is a valid purchase request, or whether the user input correlates to another module. If the user input is the purchase request, then, in a step 359, the flow control module invokes the purchasing module 229 (FIG. 2). If the user selected a module from the DVD, then, in a step 358, the flow control module (FIG. 2) accesses the selected module from the DVD. Then, in the same step 358, the playing module 222 (FIG. 2) retrieves the module from the DVD and sends it to the display module 212 (FIG. 2), which subsequently displays it the display screen.

Once the playing of the default module, identified module, or purchase information is complete, at the step 354, the flow control module checks again whether there is new user input. In one embodiment, the user can select from a menu 352 (FIG. 3) the playing of just one module (or sub-module), or the playing of a sequence of modules (or sub-modules). If the user requests the playing of just one module, the flow control module 221 (FIG. 2) selects only one file (or menu) for playing. For example, the playing of just one module is when the user requests from a menu the playing of just one movie clip, or just one subsequent menu. On the other hand, the playing of a sequence of modules is when the user requests from a menu the playing of a sequence of clips. In this case, the flow control module 221 (FIG. 2) selects no other menu until the playing of the sequence of modules is complete.

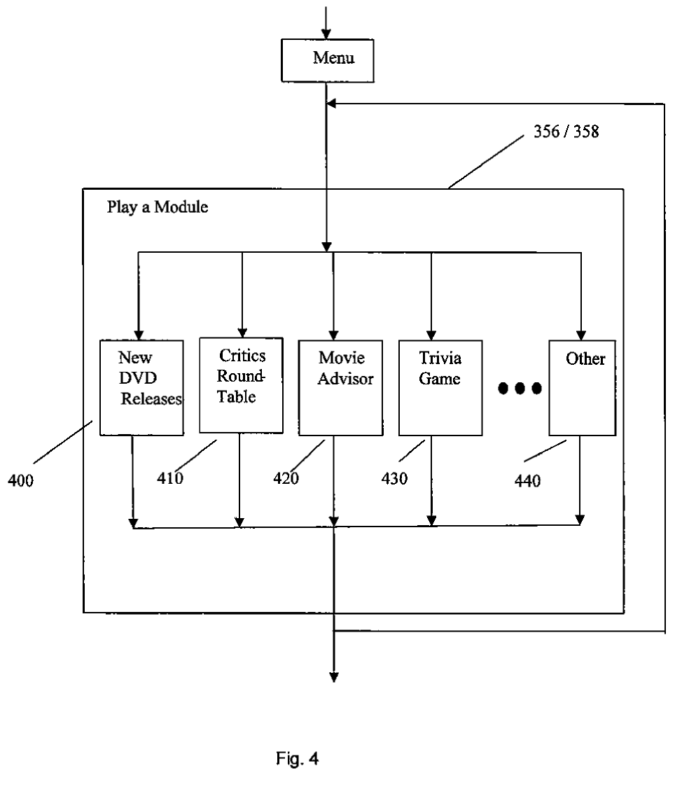

FIG. 4 is a flow chart illustrating examples of DVD modules according to an embodiment of the present invention. The play modules steps 356 and 358 (FIG. 3) can initialize the playing of a variety of modules and sub-modules stored on the DVD. The modules and sub-modules can contain menus and files, as it was described in FIG. 1A. In one embodiment, the modules and sub-modules can contain the following menus and files: new DVD releases 400, critics' round-table 410, movie advisor 420, trivia game 430, or other promotional or informational topics 440. The user can request the playing of any of these modules and/or their sub-modules by making a selection from an appropriate menu via the interface 160 (FIG. 2). Alternatively, the user can be directed to these modules from appropriate default sequences, selected by the flow control module (FIG. 2).

In one embodiment of the present invention, the user can select from a menu the playing of just one module (or sub-module), or the playing of a sequence of modules (or sub-modules). If the user selection module 224 (FIG. 2) identifies a user request for the playing of just one module, the flow control module 221 (FIG. 2) selects only one file (or menu) for playing. For example, the playing of just one module is when the user requests from a menu the playing of just one movie clip, or just one subsequent menu. On the other hand, the playing of a sequence of modules is when the user requests from a menu the playing of a sequence of clips. In this case, the flow control module 221 (FIG. 2) selects no other menu until the playing of the sequence of modules is complete.

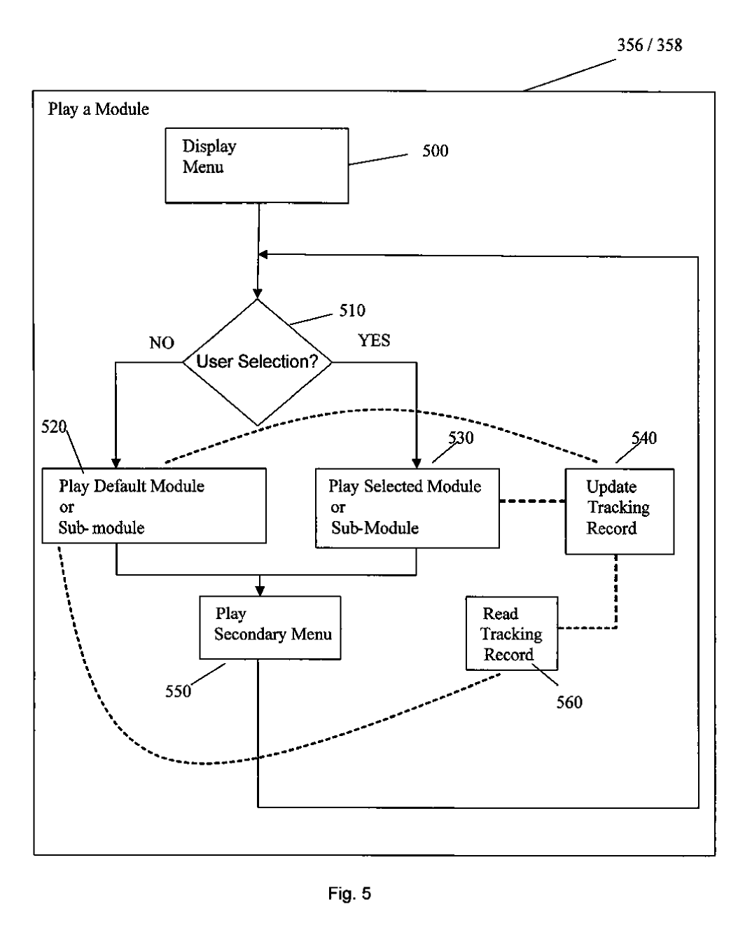

FIG. 5 is a flow chart illustrating the details of the steps 356/358 of FIG. 3 performed by the functional blocks involved in the playing of one DVD module in one embodiment of the present invention. In a first step 500, the flow control module 221 (FIG. 2) of the media player displays a menu, which contains selection options available to the user. The user can either make a selection from the menu or can let the flow control module 221 (FIG. 2) select which DVD module will be played next (default).

If the user makes no selection, then, in a step 520, the media player plays a default module or sub-module. In the step 520, the flow control module 221 (FIG. 2) of the media player selects the next DVD module based on a default sequence of modules stored on the DVD, or, if there is a tacking record of user selections, the flow control module can read the tracking record in a sub-step 560 and use that information in determining the default module or sub-module. While performing the step 520, the tracking module 226 (FIG. 2) updates the tracking record in a sub-step 540. Then, the playing module 222 (FIG. 2) of the media player plays the identified module or sub-module. Once the playing of the default module is complete, the flow control module of the media player proceeds to a step 550, and plays a secondary menu, which will be described below.

If the user makes a valid selection from the introductory menu, in a step 530, the media player plays the selected module or sub-module from the DVD. While performing the step 530, the tracking module 226 (FIG. 2) reads the tracking record in the sub-step 560 and updates the tacking record in the sub-step 540. Then, the playing module 222 (FIG. 2) of the media player plays the selected module or sub-module. Once the playing of the selected module (or sub-module) is complete, the flow control module of the media player proceeds to a step 550 to select a secondary menu. Once the flow control module selects the secondary menu, the playing module 222 (FIG. 2) of the media player plays it on the display screen. Then, the user can either make a selection from the secondary menu or can let the flow control module select which DVD module will be played next.

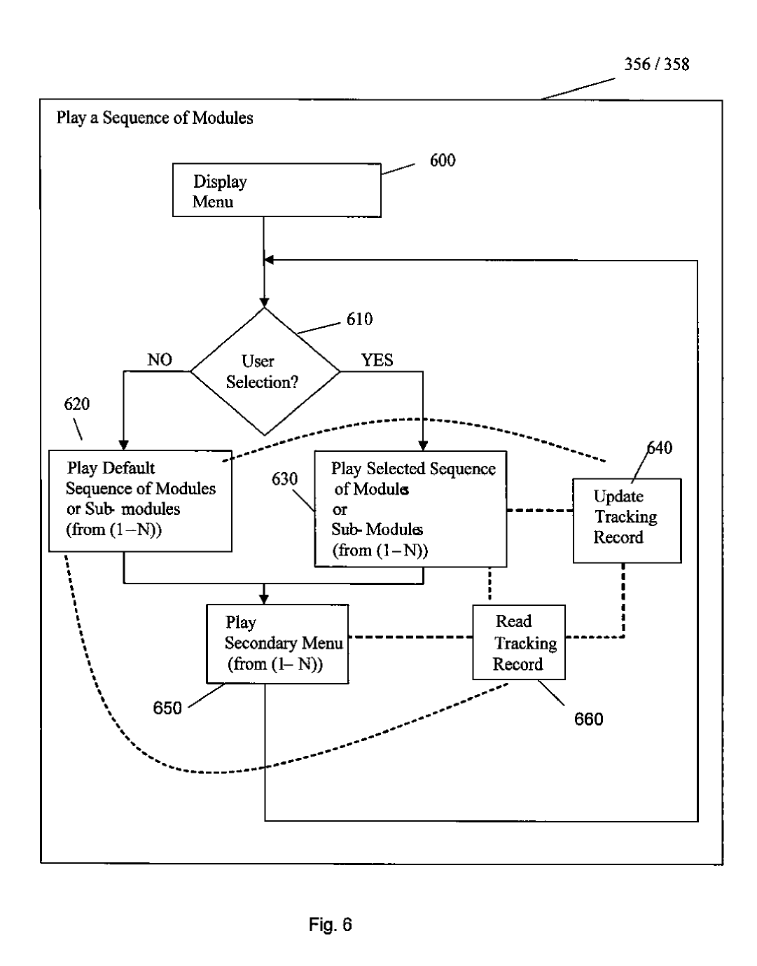

FIG. 6 is a flow chart illustrating the details of steps 356/358 of FIG. 3 involved in the playing of a sequence of DVD modules in one embodiment of the present invention. In a first step 600, the flow control module 221 (FIG. 2) of the media player displays a menu, which contains selection options available to the user. The user can either make a selection from the menu or can let the flow control module 221 (FIG. 2) select which sequence of D)VD modules will be played next.

If the user makes no selection, then, in a step 620, the media player plays one of “N” default sequences of modules or sub-modules. In the step 620, the flow control module 221 (FIG. 2) of the media player selects the next sequence of DVD modules based on a default sequence of modules stored on the DVD, or, if there is a tracking record of user selections, the flow control module can read the tracking record in a sub-step 660 and use that information in determining the default sequence of modules or sub-modules. While performing the step 620, the tracking module 226 (FIG. 2) updates the tracking record in a sub-step 640. Then, the playing module 222 (FIG. 2) of the media player plays the identified sequence of modules or sub-modules. Once the playing of the default sequence of modules (or sub-modules) is complete, the flow control module of the media player proceeds to a step 650, and plays a secondary menu, which will be described below.

If the user makes a valid selection from the introductory menu, in a step 630, the media player plays the selected sequence of modules or sub-modules from the DVD. The valid selection has to indicate one of the “N” sequences of modules or sub-modules. While performing the step 630, the tracking module 226 (FIG. 2) reads the tracking record in the sub-step 660 and updates the tracking record in the sub-step 640. Then, the playing module 222 (FIG. 2) of the media player plays the selected sequence of modules or sub-modules. Once the playing of the selected sequence of modules (or sub-modules) is complete, the flow control module of the media player proceeds to a step 650 to select one of “N” secondary menus. Once the flow control module 221 (FIG. 2) selects the secondary menu, the playing module 222 (FIG. 2) of the media player plays it on the display screen. Then, the user can either make a selection from the secondary menu or can let the flow control module select which sequence of DVD modules will be played next.

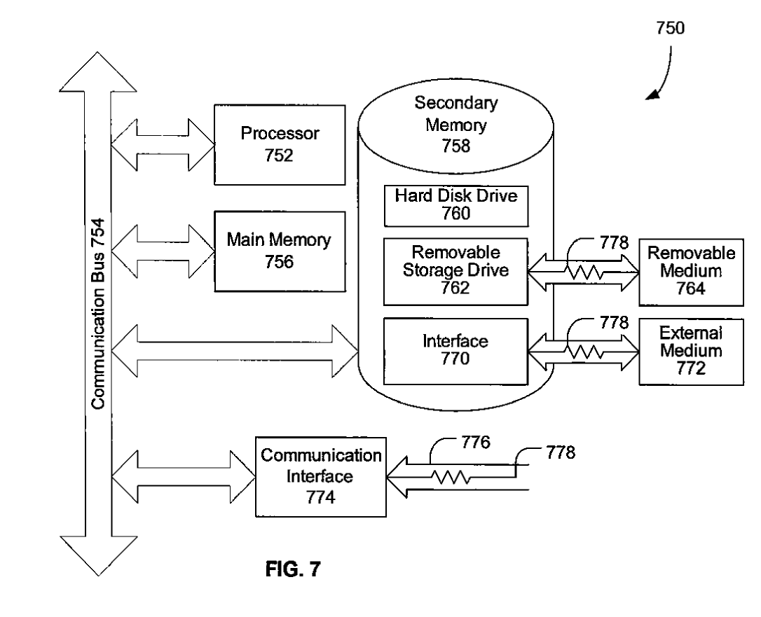

FIG. 7 is a block diagram illustrating an example computer system that may be used in connection with various embodiments described herein. In this description, the term “computer readable medium” is used to refer to any media used to provide computer executable code (e.g., software and computer programs) to the computer system 750. Examples of these media include main memory 756, secondary memory 758 (including hard disk drive 760, removable storage medium 764, and external storage medium 772), and any peripheral device communicatively coupled with communication interface 774 (including a network information server or other network device). These computer readable mediums are means for providing executable code, programming instructions, and software to the computer system 750.

In an embodiment that is implemented using software, the software may be stored on a computer readable medium and loaded into computer system 750 by way of removable storage drive 762, interface 770, or communication interface 774. In such an embodiment, the software is loaded into the computer system 750 in the form of electrical communication signals 778. The software, when executed by the processor 752, preferably causes the processor 752 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of sill will further appreciate that the various illustrative logical blocks, modules, circuits, and algorithm steps described in connection with the embodiments disclosed herein can often be implemented as electronic hardware, computer software, or combinations of both. To clearly illustrate his interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit without departing from the invention.

Block described in the FIGS. 1-6 can be implemented as modules as described above. Therefore, every term “block” in the FIGS. 1-6 and their descriptions can be replaced with the term “module.”

The above description of the disclosed embodiments is provided to enable any person skilled in the art to make or use the invention. Various modifications to these embodiments will be readily apparent to those skilled in the art, and the generic principles defined herein can be applied to other embodiments without departing from the spirit or scope of the invention. Thus, the invention is not intended to be limited to the embodiments shown herein but is to be accorded the widest scope consistent with the principles and novel features disclosed herein.

While the particular system and method herein shown and described in detail is fully capable of attaining the above described objects of this invention, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A method for playing an interactive digital catalog, the method comprising:
identifying a list of media files on a digital data carrier;
accepting user input to play the media files;
playing the media files on a multimedia display;
tracking the media files which have been played;
creating a tracking record of the sequence of media files played;
executing a preset sequence in which the media files are played if no user input is received;
communicating with a point of purchase system via a network connection;
displaying the information from the point of purchase system;
allowing the user to select products for purchase;
communicating the selected products to the point of purchase system;
accepting payment information from the user; and
transmitting payment information to the point of purchase system via the network connection.

2. A method set forth in claim 1, wherein the media files include movie clips, movie reviews, movie trailers, interviews with movie stars and movie trivia.

3. A method set forth in claim 1, wherein the media files include a list of products, and promotional materials for the products.

4. A method set forth in claim 1, wherein communications with a point of purchase system can by done by telephone or by internet.

5. A computer readable medium having stored thereon one or more sequences of instructions for causing one or more processors to perform steps for playing an interactive digital product catalog, the steps comprising:
displaying an introductory menu displaying playing options to the user,
receiving user input indicative of a user selection;
displaying one of a plurality of content modules stored on the digital data carrier corresponding to the user selection, wherein the content modules have information relating to one or more products;
tracking the user input; and
creating a record of the sequence of the content modules which have been displayed.

6. The computer readable medium of claim 5 wherein the steps further comprise communicating with a point of purchase system.

7. A method for promoting and purchasing products using a digital catalog, the method comprising:
identifying products to be marketed;
creating promotional materials for the identified products;
storing a copy of the promotional materials in digital form;
electronically providing the user with access to the promotional material;
allowing a user to select products for purchase;
accepting a credit card or gift card number from the user; and
remotely purchasing one or more of the selected products by way of the credit card or gift card number.

8. A method of claim 7 wherein the remote purchasing is done via the internet.

9. A method of claim 7 wherein the sequence of products displayed is controlled by a flow control module which contains a default sequence.

10. A digital catalog system for the purchasing of selected products; the system comprising:
a list of products;
promotional material for the products;
a network connection to a point of purchase system;
a carrier; and
a digital data carrier attached to the carrier and storing instructions that, when executed by a media player, cause the media player to perform a method comprising
retrieving and displaying an introductory menu displaying playing options to a user,
receiving user input indicative of a user selection,
retrieving and displaying one of a plurality of content modules stored on the digital data carrier corresponding to the user selection; wherein the content modules have information relating to one or more of the selected products.

11. The system of claim 10 wherein the digital data carrier further comprises a tracking module storing instructions that, when executed by a media player, cause the media player to perform a method comprising:
creating and updating a tracking record of the sequence of content modules which have been displayed by the media player; and
creating and updating a record of user inputs.

12. The system of claim 10 wherein the record of user inputs is played by a flow control module if no alternate user input is received.
